(19) United States
(12) Patent Application Publication
(10) Pub. No.: US 2006/0236709 A1
(43) Pub. Date: Oct. 26, 2006

(54) Spacing-saving superconducting device

(76) Inventor: Florian Steinmeyer, Herzogenaurach (DE)

Correspondence Address: SCHIFF HARDIN LLP;Patent Department, 6600 Sears Tower, 233 South Wacker Drive, Chicago, IL, 60606, US

(21) Appl. No.: 11/316,799

(22) Filed: Dec. 22, 2005

(30) Foreign Application Priority Data
Dec. 22, 2004 (DE) 10 2004 061 869.0

(51) Int. Cl. F25D 23/12; F17C 9/02; F28D 15/00

(52) U.S. Cl. 62/259.2; 62/50.2; 165/104.21

(57) ABSTRACT

A superconducting device has a magnet with at least one superconducting winding and a cryogenic unit that has at least one cryogenic head. The device further has a conductor system with at least one conduit for a cryogenic agent (circulating therein according to a thermo-siphon effect) for indirect thermal coupling of the at least one winding to the at least one cryogenic head. The cryogenic head is below a highest-situated point of the at least one winding.

### BACKGROUND OF THE INVENTION

1. Field of the Invention

The present invention concerns a superconducting device of the type having a magnet with at least one superconducting winding cryogenic unit having at least one cryogenic head, and a conductor system with at least one conduit for a cryogenic agent (circulating therein according to a thermo-siphon effect) for indirectly thermally coupling the at least one winding to the at least one cryogenic head.

2. Description of the Prior Art.

In general, liquid helium is used for cooling superconducting magnets, in particular in magnetic resonance apparatuses. The superconducting magnet is located in a bath composed of liquid helium (see U.S. Patent No. 6,246,308). Magnets with cryogenic units are available in which vaporized helium is condensed so that losses of helium are precluded as much as possible. The magnets are surrounded by pressure reservoirs that also contain the liquid helium. Upon an operating interruption of the magnets, an unintended transition of initially superconducting parts of the magnets into the normal conductive state can occur, causing the magnet-heat in an avalanche effect. A large part of the helium is thereby vaporized. This is known as a quench. In order to avoid damage, the pressure reservoir must be designed for large pressures in the range of multiple bars that can occur during the quench. The pressure reservoir consequently must be designed to be very stable, which can be realized, for example, by a wall thickness of multiple millimeters. The pressure reservoir is additionally surrounded by a vacuum vessel for thermal isolation from the environment. This results in high production costs and, in the case of magnetic resonance apparatuses, has the additional disadvantage that the distance between the magnet and a patient is increased. Bath cooling, moreover, has the disadvantage that multiple hundreds of liters of fluid helium are required to cool the magnet, that are lost in the event of a quench. This leads to increased costs for the operator of the magnetic resonance apparatus.

A number of cooling devices alternative to the bath cooling are known that in part use different approaches.

A cooling system for indirect cooling of a superconducting magnet is described in U.S. Pat. No. 4,578,962. The superconducting windings of the magnet contain channels through which liquid helium flows. By means of a feed channel disposed below the channels, helium flows from a reservoir situated above the magnet through the channels to a return feed channel arranged above the windings. The evaporated helium is led back through the return feed channel into the reservoir, where a cryogenic-head is provided for condensation. Such a cooling system operates according to an effect known as the thermo-siphon effect and requires significantly less liquid helium in comparison to bath cooling. Less costs arise for the operator in the event of a quench. Moreover, a large-volume pressure vessel is not required since the helium is entirely located within the channels and the reservoir.

Cooling systems comparable to this are also described by M.A. Green in “Cryogenics”, Volume. 32, 1992, ICEC Supplement, pages 126 through 129 and are known from U.S. Pat. No. 4,020,275, EP 0 392 771 and DE 36 21 562 A1.

A comparable cooling system is described by J.C. Lottin et al. in Proc. 12^{th} Int. Cryog. Engng. Conf. [ICEC 12], Southampton, UK, 12-15 Jul. 1988, published by Butterworth & Co (UK), pages 117 through 121. The cooling unit described here operates according to the thermo-siphon effect, analogous to that described above, but pressure valves that protect the helium in the reservoir from heating in the event of a quench are mounted between the reservoir and the channels for the liquid helium. The helium located in the channels within the magnet and vaporizing given a quench is conducted via circumvention conductors with corresponding pressure valves at the reservoir. Given a quench, only a fraction of the helium present in the system thus vaporizes.

A cooling unit that forces helium gas under pressure into a superconducting winding through cooling channels is known from U.S. Pat. No. 5,461,873. The gas is cooled by a cryogenic unit and is pumped through the channels under pressure. A return feed conduit is located above the channels, the return feed conduit feeding the gas back to the cryogenic unit in a manner analogous to the examples above.

Due to the cryogenic unit arranged above the magnet, the described magnets exhibit a relatively high installation height in comparison to magnets with bath cooling. This is particularly disadvantageous in the case of magnets for magnetic resonance apparatuses, since these are generally to be installed in rooms with established headroom (2.5 to 3 meters). The diameter of the magnet must consequently be selected smaller than would be necessary given the use of a bath cooling. This in turn has a disadvantageous effect on the flux density of the magnet and therewith on the imaging properties of the magnetic resonance apparatus. In principle, this could be compensated by an increase of the number of windings or of the ratio of the superconducting material to a corresponding wire, but neither approach is practical due to cost reasons.

Cooling methods are also known that function without liquid helium. Cryogenic units in the form of cryogenic coolers with closed helium pressure gas loops are preferably used. These have the advantage that the cryogenic capacity is for the most part available at the push of a button and the user is spared the handling of super-cold fluids. In the a use of such cryogenic units, the superconducting winding is only indirectly cooled by heat conduction to a cryogenic head of a refrigerator; the superconducting winding thus is free of cryogenic agent (compare Proc. 16^{th} Int. Cryog. Engng. Conf. [ICEC 16], Kitakyushu, JP, 20th-24th May 1996, published by Elsevier Science, 1997, pages 1,109 through 1,132).

In superconducting magnets, refrigerator cooling systems have been realized using connections with good heat conductivity (such as, for example, in the form of copper bars or bands that can also be fabricated so as to be flexible) between a cryogenic head of a cryogenic unit and the superconducting winding of the magnet (compare the cited literature passage from ICEC 16, in particular pages 1,113 through 1,116). Depending on the distance between the cryogenic head and the object to be cooled, the large cross-sections required for a sufficiently good thermal coupling then lead to a considerable increase of the cryogenic mass. This is particularly disadvantageous in the spatially extensive magnet systems that are typical in magnetic resonance apparatuses due to the extended cooling times.

Instead of such a thermal coupling of the (at least one) winding with the (at least one) cryogenic head through heat-conducting solid bodies, a conduction system can also be provided in which a helium gas flow circulates (compare, for example, U.S. Pat. No. 5,485,730).

The described cooling devices for superconducting magnets operate in a quite satisfactory manner. It is the object of the present invention to provide a further-improved magnet system that is particularly suited for use in magnetic resonance apparatuses.

This object is achieved by a superconducting device having a magnet with at least one superconducting winding, a cryogenic unit with at least one cryogenic head and a conduction system with at least one conduit for a cryogenic agent (circulating therein according to a thermo-siphon effect) for indirectly thermally coupling the at least one winding to the cryogenic head, with the cryogenic head being located below a highest point of the at least one winding. This prevents the aforementioned disadvantage of known thermo-siphon cooling systems, wherein the cryogenic unit is arranged above the windings. The magnet thus can be fashioned larger in comparison with such known solutions. Given room heights in the range of 2.5 to 3 m in which magnetic resonance apparatuses are typically to be installed, the laterally-arranged cryogenic unit allows approximately 40 to 50 cm more space to be available for the diameter of the magnet than in known solutions with thermo-siphon cooling. The entire room height is available for accommodation of the magnet or an insulation reservoir in which the magnet is located (as the largest unit of the magnetic resonance apparatus).

The cryogenic agent (for example helium) circulating according to the thermo-siphon effect is condensed in the cryogenic head and transported via the conduction system to the at least one winding. Since the cryogenic head is arranged next to the winding, it is not possible to fill the conduit completely with liquid helium. This has the consequence that a part of the winding is in contact only with gaseous (and thus warmer) helium. For operation of the magnet a homogenous temperature distribution is required for the entire winding. In an embodiment of the invention, therefore, the winding has additional material of higher heat conductivity than the superconducting material provided in the winding. Due to this additional material the part of the winding that is not directly in contact with the liquid helium can be thermally coupled to the liquid helium via the material with high heat conductivity. In the case of cooling or temperature fluctuations, the heat can be transported away to the helium bath via the material with high heat conductivity.

### DESCRIPTION OF THE DRAWINGS

FIG. 1 shows a known embodiment of a magnet with thermo-siphon cooling.

FIG. 2 shows a preferred embodiment of the invention.

FIG. 3 is a section through a magnetic resonance apparatus with a magnet according to the embodiment of the invention shown in FIG. 2.

FIG. 4 is a section through a part of a superconducting winding used with the invention.

FIG. 5 is a section through a part of an alternative embodiment of a superconducting winding used with the invention.

FIG. 6 is a section through another embodiment of a magnetic resonance apparatus in accordance with the invention.

FIG. 7 is a section through a magnetic resonance apparatus with a magnet according to a further embodiment of the invention.

FIG. 8 is a section through another embodiment of a magnetic resonance apparatus in accordance with the invention.

FIG. 9 is a section through a further embodiment of a magnetic resonance apparatus in accordance with the invention.

FIG. 10 is a section through a magnetic resonance apparatus with a magnet according to the embodiment of the invention shown in FIG. 9.

FIG. 11 is a section through a conduit in accordance with the invention.

FIG. 12 is a section through another embodiment of a conduit in accordance with the invention.

### DESCRIPTION OF THE PREFERRED EMBODIMENTS

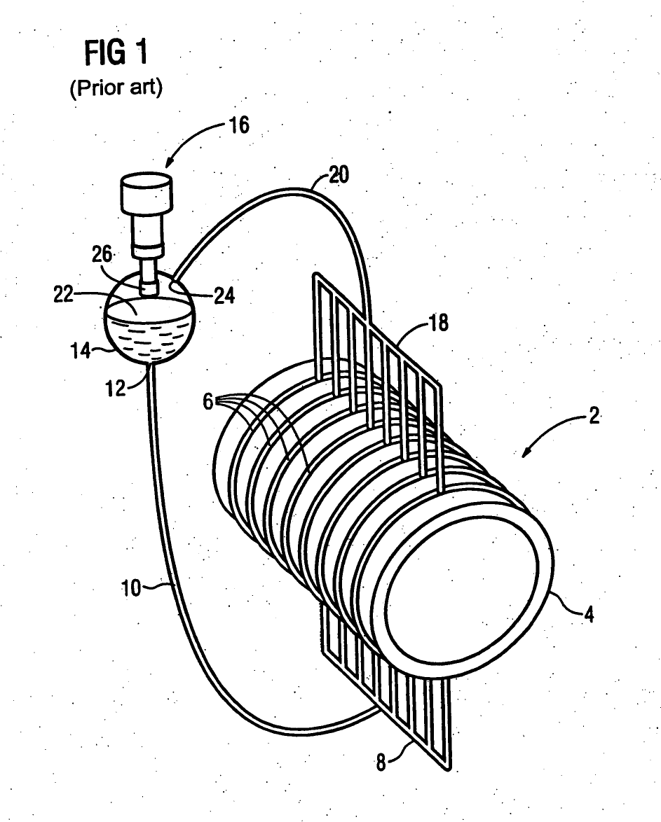

FIG. 1 shows a superconducting magnet 2 with a cooling system in a schematic perspective representation. An arrangement of the shown type is, for example, known from DE 33 44 046 C2. The magnet 2 is cylindrical and has a number of superconducting windings that are not shown here. The windings are wound around a coil body 4 in a known manner, for example within recesses. Conduits 6 for accommodation of a cryogenic agent (for example liquid helium) are embedded in a number of cross-section planes of the coil body 4. The conduits 6 are copper tubes. For embedding they can alternatively run in further recesses around the coil body 4 and exhibit a good thermal contact with the coil body 4. The thermal contact can be achieved by known techniques such as welding, force fitting, casting or bonding. Stainless steel or aluminum can also be used as alternative materials for the conduits 6. Cooling of the coil body 4 and the superconducting windings is achieved with liquid helium located within the conduits 4.

An axially-aligned distributor line 8 that is connected with all conduits 6 is arranged below the coil body 4. The distributor line 8 is connected via a feed line 10 with a floor outlet (discharge) 12 of a reservoir 14 for intake of liquid helium. The reservoir 14 is part of a cryogenic unit 16 arranged above the magnet 2. An axially-aligned collection line 18 that is connected with all conduits 6 is arranged above the coil body 3, and is more connected via a return line 20 with an upper part of the reservoir 14. A helium level 22 of the reservoir 14 lies below an input 24 of the return line 20. The cryogenic unit 16 has a cryogenic head 26 at a temperature sufficiently low to condense gaseous helium. Due to the feed line 10 situated below the reservoir 14, utilizing gravity the same helium level 22 as in the reservoir 14 arises in the entire conduit system. In the embodiment shown in FIG. 1, the conduits 6 within the coil body 3 are completely filled with liquid helium, such that the entire coil body 3 is uniformly cooled. Vaporized helium is supplied to the reservoir 14 via the collection line 18 and the return line 20 and condensed via the cryogenic head 26.

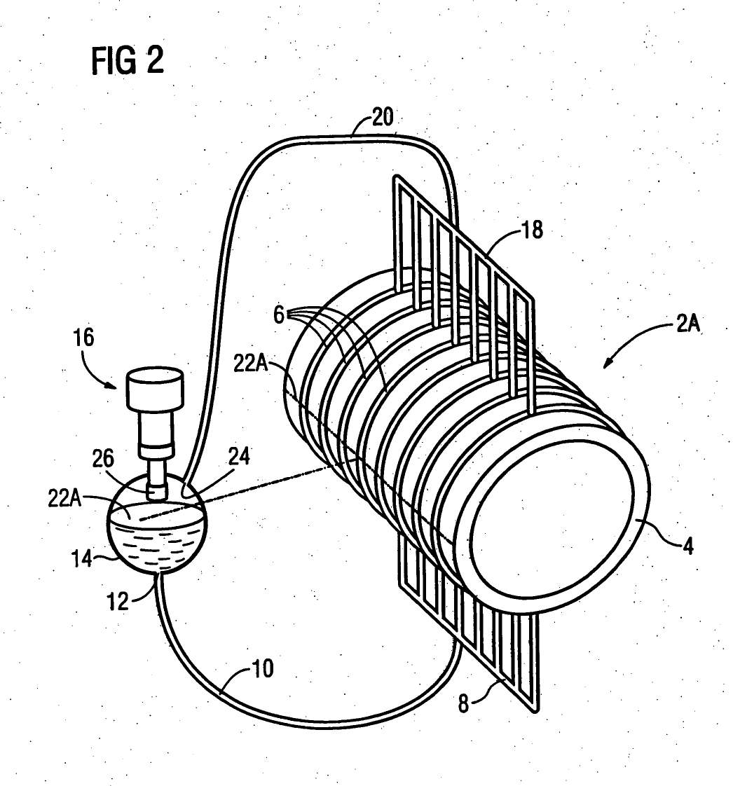

In a representation comparable to FIG. 1, FIG. 2 shows a superconducting magnet 2A according to a preferred embodiment of the invention. The internal design of the magnet 2A is comparable to the magnet 2 shown in FIG. 1. Conduits 6 are embedded in the coil body 4 and/or in the superconducting windings, the conduits 6 being connected with the reservoir 14 of the cryogenic unit 16 via the distributor line 8 and the feed line 10 or via the collection line 18 and the return line 20. In contrast to the embodiment shown in FIG. 1, the reservoir 14 is arranged next to the magnet 2A. The helium level 22A in the conduit system thus lies lower than in the embodiment of FIG. 1. The conduits 6 within the coil body 4 are accordingly not completely filled with liquid helium. Analogous to the embodiment shown above, vaporized helium is directed back via the return line 20 to the reservoir 14 where it condenses due to the cryogenic head 26. The non-uniform distribution of the cooling capacity resulting from the lower helium level 22A is compensated by the coil body 4 and the superconducting windings themselves. The part of the coil body 4 not directly in contact with the liquid helium and the superconducting windings is coupled to the liquid helium via head conduction in a manner comparable to the known principle of coupling of windings to a cryogenic cooling system. This is described in detail in connection with FIG. 3.

FIG. 3 shows a section through a part of a magnetic resonance apparatus 40 with a vacuum vessel 43 resting on feet 41 and having a patient opening 45. The magnetic resonance apparatus 40 has a magnet 2A .of the design shown in FIG. 2. Such a magnet 2A has the advantage that no helium bath is necessary for cooling. The required quantity of helium is thereby clearly reduced. The magnetic resonance apparatus 40 has a radiation shield 42 .for insulation of the magnets 2A against radiant heat. The magnetic resonance apparatus 40 is installed within a room 44.. The height (symbolized by the double arrow 46) of the magnetic resonance apparatus 42 is only slightly smaller than the height (symbolized by the double arrow 48) of the room 44. Due to the cryogenic unit 16 being arranged next to the magnet 2A, given the same room height 48 the magnetic resonance apparatus 40 (and therewith the magnet 2A) can be built larger than would be possible given the use of a magnet 2 with cryogenic unit 16 positioned above according to FIG. 1. Alternatively, the magnet can be installed in rooms with reduced room height. In comparison with a magnetic resonance apparatus with bath cooling, a pressure vessel is no longer required. Moreover, the need for liquid helium is distinctly reduced.

The magnet 2A has a number of superconducting windings 50 that are wound on the coil body 4, of which only one is shown. The conduit 6 that is connected with the reservoir 14 via the feed line 10 and the distributor line 8 is fashioned within the winding 50. Above the superconducting winding 50, the collection line 18 is likewise connected with the reservoir 14 via the return line 20. The helium level 22A is equally high in the conduit 6 and in the reservoir 14. Below the helium level 22A the winding is in direct contact with the liquid helium, so it is cooled. The coupling between the winding 50 and the liquid helium ensues by heat conduction in the winding material. The distance to be bridged is relatively low, as is indicated by the arrows 52. Due to the direct contact between the winding 50 and the coil body 4, the latter is likewise cooled. Alternatively, the conduit 6 can merely be situated in the coil body 4, which must then be in good thermal contact with the winding 50. This can be ensured, for example, by winding a wire under tension to form the winding on the coil body 4.

In contrast, only gaseous helium is present in the conduit 6 above the helium level 22A. The parts of the winding 50 and of the coil body 4 situated above the helium level 22A thus are only in direct contact with helium gas. For dissipation of heat from the upper part it is necessary to conduct the heat along the winding 50 to the liquid helium, which is indicated by the arrows 54. A high heat conductivity of the coil body 4 or of the winding 50 is necessary for transport of the heat over this relatively long distance. By use of materials with good thermal conductivity (such as, for example, high purity copper, aluminum) it is possible to couple the entire winding 50 to the liquid helium and to thus operate the magnet 2A at a temperature of 4.2 K.

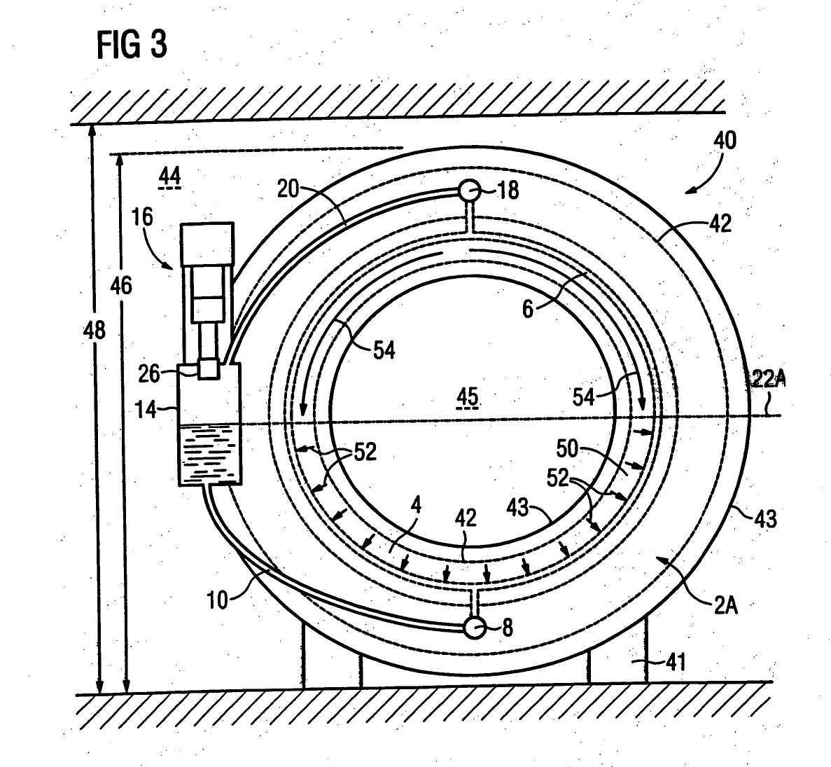

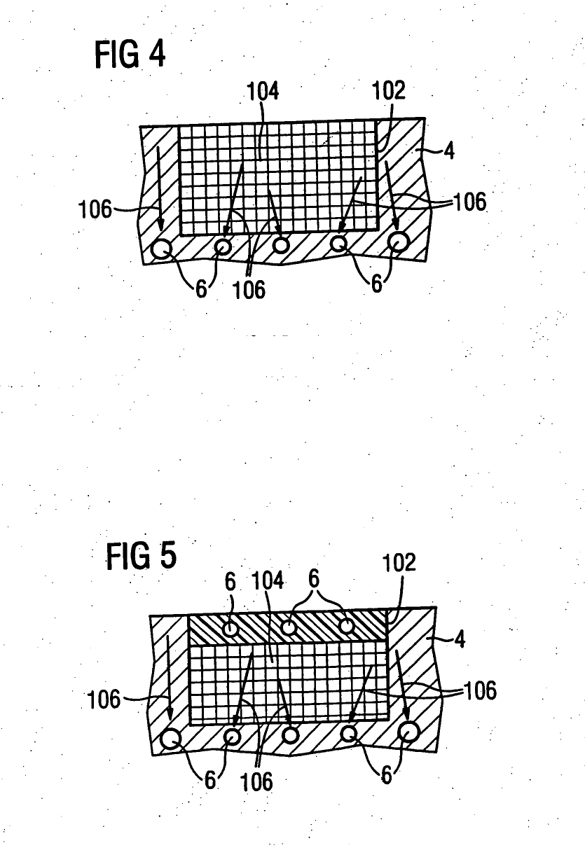

FIGS. 4 and 5 each show an excerpt of a section through the coil body 4 transverse to a winding 50. In FIG. 4, a groove 102 in which a connection wire is wound is molded in the coil body 4. The connection wire is thereby wound around the coil body 4 multiple times, but here is shown only as a winding packet 104. The connection wire is known and, for example, has a number of filaments made from a superconducting material such as, for example, NbTi, Nb₃Sn, MgB₂ or a high-temperature superconductor. The filaments are, for example, embedded in a copper matrix, whereby the copper matrix is electrically insulated.

In known production methods, the winding packet 104 is cemented with epoxy resin during or after the winding and mechanically stabilized. The groove 102 serves for shaping of the winding packet 104 during the winding event and simultaneously for thermal coupling of the winding packet 104 to the coil body 4. Conduits 6 for accommodation of the helium are embedded in the coil body 4. The coupling of the winding packet 104 to the helium in the conduits 6 ensues by heat conduction through the epoxy resin in the winding packet 104 and the material of the coil body 4. The heat transport is indicated by arrows 106. In the event that the heat conductivity of the coil body 4 is not sufficient, additional material with high heat conductivity (such as highly pure aluminum or copper) can be introduced into the coil body 4. Due to the high heat conductivity it is possible that the parts of the winding 50 shown in FIG. 3 and situated above the helium level are thermally coupled to the liquid helium via heat conduction of the coil body 4 and the epoxy resin and are thereby cooled.

FIG. 5 shows an alternative exemplary embodiment for the design of the winding packet 104 in the groove 102 of the coil body 4. Here conduits 6 are also embedded in the winding packet 104 and thermally coupled by.. sealing with epoxy resin. The design otherwise corresponds to that shown in FIG. 4.

FIG. 6 shows an alternative embodiment of the winding 50 shown in FIG. 3. The surrounding vacuum vessel is not shown here. In addition to the design already described, the reservoir 14 comprises a pressure connection 152 at the floor outflow 12. This pressure connection 152 can be connected with an external feed line 154 via which a coolant can be introduced into the feed line 10 under pressure. This is in particular helpful for a cooling process of the magnet 2B from room temperature to the operating temperature of 4.2 K in order to increase the cooling capacity. Liquid nitrogen, for example, which is distinctly more cost-effective than helium, is suitable for this purpose. No helium is present in the system during the cooling process with liquid nitrogen.

Due to the increased pressure it is possible to flush the conduit 6 running within the winding. 50 with liquid nitrogen such that the magnet 2B rapidly cools. The distance to be bridged for the heat is less and is indicated by the arrows 52. The nitrogen is conducted back via the return line 20 into the reservoir 14, where vaporized nitrogen exhausts via an over-pressure valve 156. By means of the liquid nitrogen a temperature of 77 K can be achieved; after the removal of the nitrogen from the system, .liquid helium is filled into the reservoir for the further cooling down to the operating temperature.

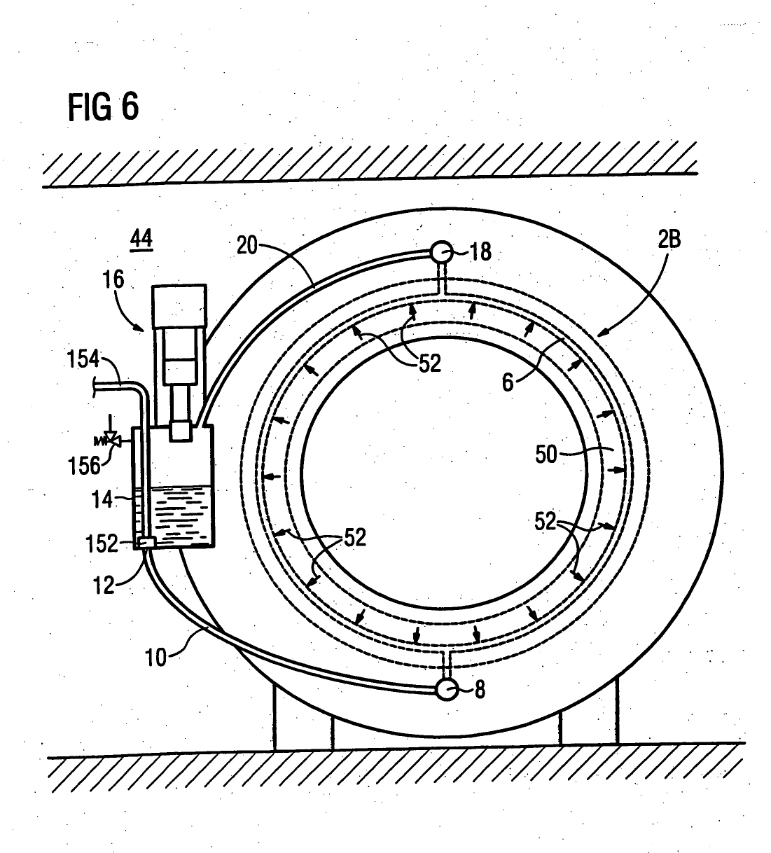

FIG. 7 shows an alternative embodiment of the magnetic resonance apparatus 40 shown in FIG. 3. Multiple (in the present example two). windings 50A and 50B are thereby fashioned with different diameters. A conduit 6 that is respectively connected with the distributor line 8 and the collection line 18 is formed in each winding. The functionality corresponds to that already explained in connection with FIG. 3. Alternatively it is possible to connect the various conduits 6 with the reservoir 14 (which is not shown here) via different distributor lines and collection lines.

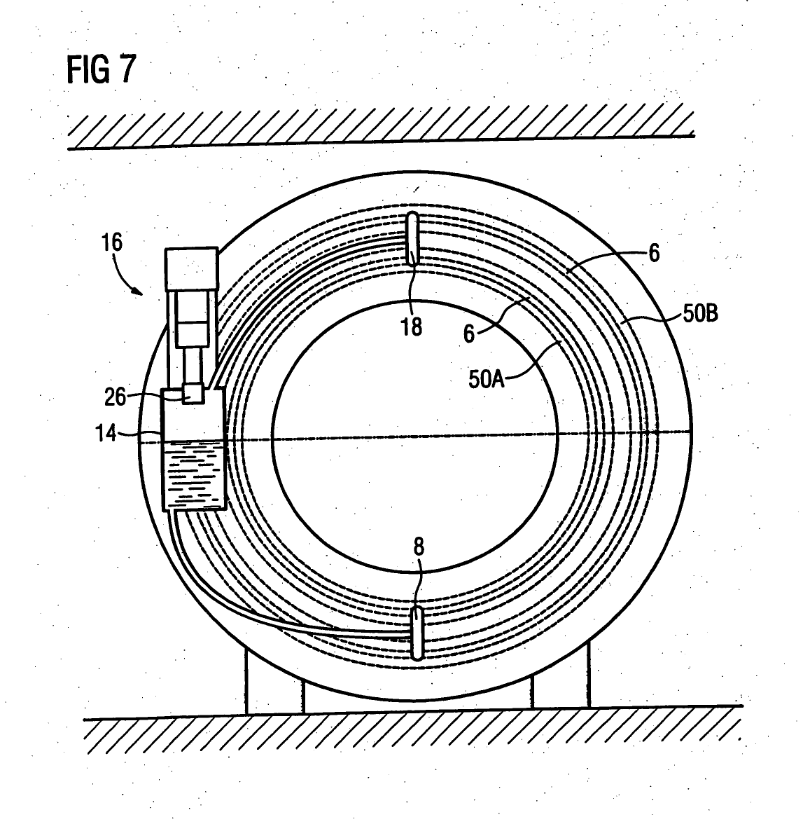

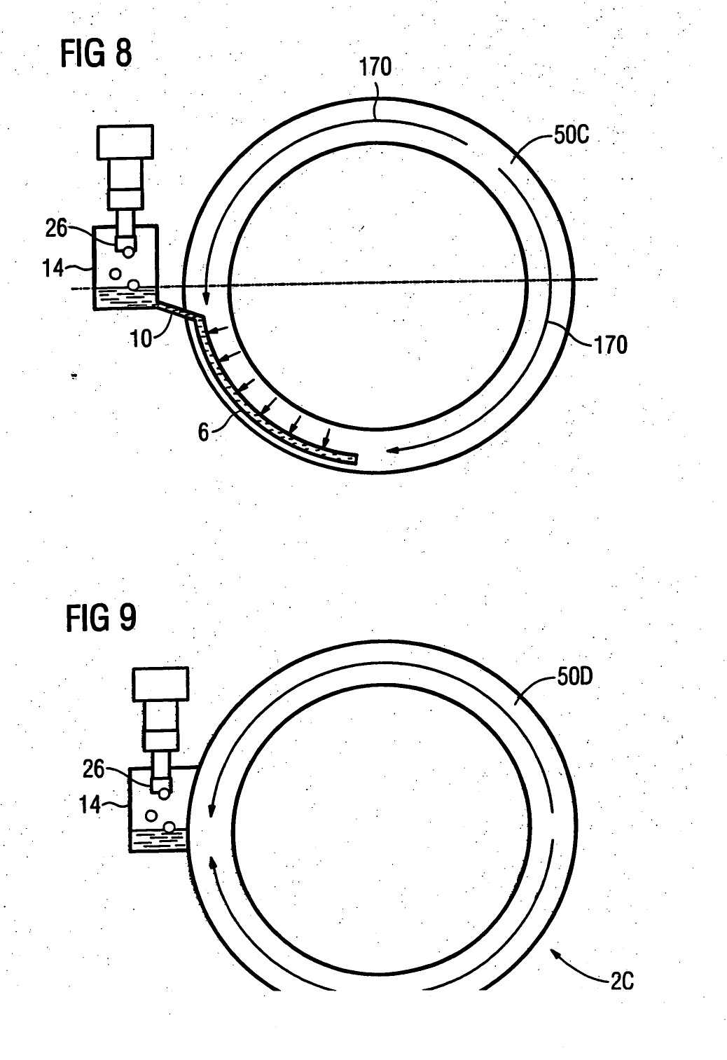

FIG. 8 shows an alternative embodiment of the invention. Here the return conduction of the gaseous helium does not occur via the separate return line 20 as in FIG. 3, but rather via the feed line 10 for the liquid helium. The conduit 6 in this embodiment is fashioned only in a quarter of the circumference of the winding 50C. Within the conduit 6 nearly completely filled with helium, vaporized helium within the liquid helium is conducted back into the reservoir 14 and there condensed via the cryogenic head 26. In contrast to the exemplary embodiment shown in FIG. 3, the distance of the most remote part of the superconducting winding 50C from the liquid helium is further removed, meaning that heat must be transported over a greater distance to the liquid helium, which is indicated by arrows 170. This can be achieved by an enlargement of the groove 102 of the winding 50C or by the use of materials with higher heat conductivity.

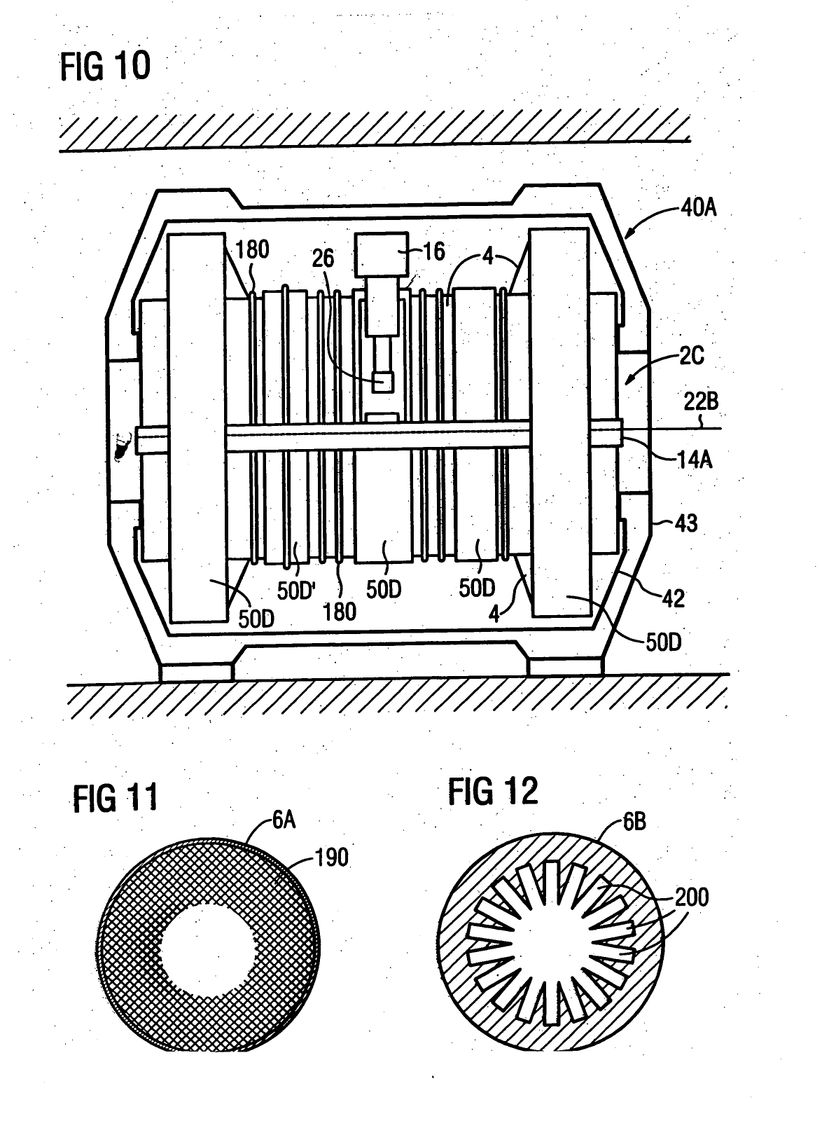

FIG. 9 shows a further alternative embodiment of the invention. Here no conduit is provided in the circumferential direction of the winding 50D of the magnet 2C. Instead, the superconducting winding 50D is directly thermally coupled to the reservoir 14. The reservoir 15 appropriately extends over the complete length of the magnet perpendicular to the plane of the drawing. This can be seen in FIG. 10, which shows a side view of a magnetic resonance apparatus. Here an even higher heat conductivity is required in comparison with the embodiments shown in FIGS. 3 and 8. Alternatively, a larger cross-section of the coil body 4 can contribute to the heat transport.

FIG. 10 shows a section through a magnetic resonance apparatus 40A with a magnet 2C according to the embodiment shown in FIG. 9. The vacuum vessel 43 of the magnetic resonance apparatus 40A is shown sectioned. The radiation shield 42 (likewise shown in section) that surrounds the coil body 3 on which a number of superconducting windings 50D of different diameter are wound is located within the vacuum vessel 43. The reservoir 14A is filled up to a helium level 22B with liquid helium. The reservoir 14A is shaped oblong and is in good thermal contact with the windings 50D. In this embodiment, the heat conductivity of the windings 50D or of the coil body 4 must be larger relative to the embodiment shown in FIG. 3. Vaporized helium is condensed by the cryogenic head 26. Additional cooling rings 180 can be mounted around the coil body 4 for better thermal coupling of the coil body 4 to the reservoir. These can, for example, copper or aluminum windings and are in good thermal contact with both the reservoir 14A and the coil body 3. It is additionally possible to wind such cooling rings 180 around the windings 50D so that the thermal contact between the windings 50D and the reservoir 14A is improved. This is exemplarily shown using a winding 50D′.

FIG. 11 shows a section through a preferred embodiment of a conduit 6A. In the embodiments previously described, conduits 6 with conventional metal surfaces were used. The inside of the conduit 6A shown in FIG. 11 is connected with a stainless steel mesh 190 that acts as a wick. This design functions as a heat pipe. Via the stainless steel mesh 190, liquid helium is transported counter to the force of gravity such that it also arrives at parts of the conduit 6A lying above the helium level. The cooling capacity is thereby improved.

As an alternative to the embodiment shown in Figure 11, it is possible to enlarge the surface of the conduit 6B by providing a number of depressions, as is schematically shown in FIG. 12. Via the depressions 200, liquid helium is transported counter to the force of gravity (analogous to the effect of the stainless steel mesh 190) and thus also wets parts of the conduit 6B situated above the helium level.

A magnet executed according to the invention with a cryogenic unit for a magnetic resonance apparatus has the advantage of a compact design. In comparison to bath cooling, a stable pressure reservoir for liquid helium is not required. In addition to saving production costs, this also saves space that, for example, can be used to accommodate a larger magnet. The imaging properties of the corresponding magnetic resonance apparatus can thereby be improved given the same structural size. A distinctly reduced loss of helium in the event of a quench additionally results.

Although modifications and changes may be suggested by those skilled in the art, it is the intention of the inventor to embody within the patent warranted hereon all changes and modifications as reasonably and properly come within the scope of his contribution to the art.

I claim as my invention:

1. A superconducting device comprising:
a magnet comprising at least one superconducting winding;
a cryogenic unit comprising at least one cryogenic head;
a conductor system having at least one conduit for a cryogenic agent circulating therein according to the thermal-siphon effect that indirectly firmly couples said at least one winding to said at least one cryogenic head; and
said cryogenic unit further comprising a reservoir disposed below a highest-situated point of said at least one winding.

2. A device as claimed in claim 1 wherein said at least one winding is comprised of superconducting material and an additional material having a higher heat conductivity than said superconducting material.

3. A device as claimed in claim 1 wherein said magnet comprises a coil body, with said at least one superconducting winding being wound around said coil body.

4. A device as claimed in claim 3 wherein said coil body has at least one groove therein in which said at least one superconducting winding is disposed.

5. A device as claimed in claim 3 wherein said winding comprises a superconducting material, and wherein said device comprises a cooling ring, comprised of a material having higher heat conductivity than said superconducting material, said cooling ring surrounding said coil body.

6. A device as claimed in claim 3 wherein said at least one winding is comprised of a superconducting material, and wherein said device comprises material embedded in said coil body having a higher heat conductivity than said superconducting material.

7. A device as claimed in claim 1 wherein said magnet comprises a coil body, with said at least one superconducting winding being wound around said coil body, and wherein said at least one superconducting winding is comprised of a superconducting material, said device comprising material having a higher heat conductivity than said superconducting material, and said material having a higher heat conductivity than said superconducting material being situated at a location selected from the group consisting of in said at least one superconducting winding, in a cooling ring surrounding said coil body, and embedded in said coil body.

8. A device as claimed in claim 7 wherein said material having a higher a heat conductivity than said superconducting material is a material selected from the group consisting of copper, copper alloy, aluminum and aluminum alloys.

9. A device as claimed in claim 7 wherein said at least one conduit is at least partially formed within said material having a higher heat conductivity than said superconducting material.

10. A device as claimed in claim I wherein at least a portion of said at least one conduit proceeds parallel to said at least one superconducting winding.

11. A device as claimed in claim I wherein said at least one conduit at least partially proceeds within said at least one superconducting winding.

12. A device as claimed in claim 1 wherein said magnetic comprises a coil body, with said at least one superconducting winding being wound around said coil body, and wherein at least a portion of said at least one conduit proceeds within said coil body.

13. A device as claimed in claim 1 wherein said at least one conduit comprises a width that transfers said cryogenic agent counter to the force of gravity.

14. A device as claimed in claim 15 wherein said wick comprises a --stainless steel mesh.

15. A device as claimed in claim 1 wherein said at least one conduit has an inner surface having a plurality of depressions therein.

16. A device as claimed in claim 1 wherein said cryogenic unit comprises a pressure connection allowing pressurized cryogenic agent to be introduced into said at least one conduit.

17. A device as claimed in claim I wherein said at least one superconducting winding is comprised of a superconducting material selected from the group consisting of NbTi, Nb₃Sn, and MgB₂.

18. A device as claimed in claim 1 wherein said at least one superconducting winding comprises a high-temperature superconductor.

19. A device as claimed in claim 1 wherein said magnet is a basic field magnet of a magnetic resonance imaging apparatus.
